(19) United States
(12) Patent Application Publication
(10) Pub. No.: US 2015/0356257 A1
(43) Pub. Date: Dec. 10, 2015

(54) PATIENT STATUS NOTIFICATION

(71) Applicant: GreenLine Business Group LLC, Newark, DE (US)

(72) Inventors: Anthony Wright, Glenn Mills, PA (US); David Yeager, Wilmington, DE (US)

(21) Appl. No.: 14/524,876

(22) Filed: Oct. 27, 2014

Related U.S. Application Data
(60) Provisional application No. 62/009,853, filed on Jun. 9, 2014.
(60) Provisional application No. 62/013,242, filed on Jun. 17, 2014.

(51) Int. Cl. G06F 19/00; H04L 12/58

(52) U.S. Cl. CPC G06F 19/327; G06F 19/322; G06F 19/3406; H04L 51/24; G06Q 2220/10

(57) ABSTRACT

A server receives data for obtaining an anonymous ID associated with a resident of an assisted living facility from a first computing device. The server obtains the anonymous identifier (ID) associated with the resident of the assisted living facility. The server provides a list of selectable status updates for display on the first computing device. The server receives data indicating selection of a status update from the list of selectable status updates from the first computing device. And the server sends a status notification about the resident to a second computing device that is registered to receive notifications associated with the anonymous ID, where the status notification is based on the selected status update.

### CROSS-REFERENCE TO RELATED APPLICATION

This application claims the benefit of U.S. Provisional Application Ser. No. 62/009,853, filed on Jun. 9, 2014 and U.S. Provisional Application Ser. No. 62/013,242, filed on Jun. 17, 2014, both of which are incorporated by reference.

### TECHNICAL FIELD

This specification relates to electronic notification systems.

### BACKGROUND

In certain circumstances, individuals may wish to anonymously notify family or friends of the individual's circumstances.

### SUMMARY

In one aspect, a server receives a request for an anonymous identifier (ID) from a first computing device and generates an anonymous ID. The server receives a request to receive status notifications associated with the anonymous ID from a second computing device. The server receives a status update associated with the anonymous ID from the first computing device, and sends a status notification for the anonymous ID to the second device, where the status notification is based on the status update received from the first computing device and includes only non-personally identifiable information.

Implementations can include one or more of the following features. For example, the notification may be a mobile application specific notification. The application specific notification may be non-forwardable. The anonymous ID may be a base 36 encoded binary number.

The server may encrypt the anonymous ID and data associated with the anonymous ID with a one-way salted SHA-256 hashing algorithm, and store the encrypted anonymous ID and data associated with the anonymous ID. The request from the second computing device to receive status notifications associated with the anonymous ID may include data related to the second computing device, and the server may encrypt the data related to the second computing device with key-based encryption algorithm and store the encrypted data related to the second computing device.

In another aspect, a healthcare facility server identifies an anonymous identifier (ID) associated with a patient at a healthcare facility. The healthcare facility server identifies data indicating that the healthcare facility server has received a medical status update for the patient. In response to identifying that the data indicating the medical status update for the patient has been received, the healthcare facility server sends a request to a server to send a medical status notification about the patient to a computing device that is registered to receive notifications associated with the anonymous ID. The request includes the patient's anonymous ID and the medical status update for the patient. The medical status notification is based on the medical status update and includes only non-patient identifiable information.

Implementations can include one or more of the following features. For example, the status updates may be Health Level 7 (HL7) events. The healthcare facility server may identify that the medical status update is a patient discharge event, and, in response to identifying that the medical status update is the patient discharge event, request, that the server send a survey to the computing device that is registered to receive notifications associated with the anonymous ID.

The healthcare facility server may receive data indicating a time when visiting is discouraged, and request that the server send a notification indicating the time when visiting is discouraged to the computing device that is registered to receive notifications associated with the anonymous ID. The anonymous ID may expire a predetermined time period after having received the medical status update identified as the patient discharge event.

The notification may be a mobile application specific notification. The application specific notification may be non-forwardable. The anonymous ID may be a base 36 encoded binary number. The anonymous ID the anonymous ID and data associated with the anonymous ID may be encrypted with a one-way salted SHA-256 hashing algorithm, and the encrypted anonymous ID and data associated with the anonymous ID may be stored.

A request from the computing device to receive status notifications associated with the anonymous ID may include data related to the computing device. The data related to the computing device may be encrypted with key-based encryption algorithm, and the encrypted a data related to the computing device may be stored.

In another aspect, a system includes a first server, a second server, and a computing device. The first server is configured to identify an anonymous identifier (ID) associated with a patient at a healthcare facility, identify data indicating a medical status update for the patient has been received, and send a request, to a second server, to send a medical status notification about the patient to a computing device that is registered to receive notifications associated with the anonymous ID. The computing device configured to send a request to receive status notifications associated with the anonymous ID to the second server, and receive one or more status notifications from the second server. The second server is configured to receive the request to receive status notifications associated with the anonymous ID from the computing device, receive the request to send a medical status notification about the patient to a computing device that is registered to receive notifications associated with the anonymous ID from the first server, and send a medical status notification for the anonymous ID to the computing device. The medical status notification being based on the medical status update and including only non-patient identifiable information.

In yet another aspect, a server receives data for obtaining an anonymous ID associated with a resident of an assisted living facility from a first computing device. The server obtains the anonymous identifier (ID) associated with the resident of the assisted living facility. The server provides a list of selectable status updates for display on the first computing device. The server receives data indicating selection of a status update from the list of selectable status updates from the first computing device. And the server sends a status notification about the resident to a second computing device that is registered to receive notifications associated with the anonymous ID, where the status notification is based on the selected status update.

Implementations can include one or more of the following features. For example, the list of selectable status updates may include a text entry box, and the server may receive data indicating selection of the status update from the list of selectable status updates from the first computing device may including receiving a user entered status update. The server may screen the user entered status update for personal identifying information and remove the personal identifying information from the user entered status update. The server may screen the user entered status update for personal identifying information, and providing a warning for display on the first computing device that the user entered status update includes personal identifying information.

The notification may be a mobile application specific notification. The application specific notification may be non-forwardable. The anonymous ID may be a base 36 encoded binary number. The anonymous ID the anonymous ID and data associated with the anonymous ID may be encrypted with a one-way salted SHA-256 hashing algorithm, and the encrypted anonymous ID and data associated with the anonymous ID may be stored.

A request from the computing device to receive status notifications associated with the anonymous ID may include data related to the computing device. The data related to the computing device may be encrypted with key-based encryption algorithm, and the encrypted a data related to the computing device may be stored.

Other implementations of these aspects include corresponding systems, apparatus, and computer programs, configured to perform the actions of the methods, encoded on computer storage devices.

The details of one or more implementation of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a diagram showing an example of a system for providing anonymous status notifications.

FIG. 2 is a swim lane diagram illustrating an example of an anonymous notification process.

FIG. 3 is a flowchart showing an example of a process for providing anonymous notifications.

FIG. 4 is a diagram showing an example of a system for providing anonymous status notifications integrated with a healthcare facility patient information system.

FIG. 5 is a flowchart showing an example of a process for generating anonymous IDs.

FIGS. 6A and 6B are flowcharts showing an example of a process for providing anonymous notifications for a patient at a healthcare facility.

FIG. 7 is a diagram showing an example of a system for providing anonymous status notifications for residents of an assisted living facility.

FIG. 8 is a flowchart showing an example of a process for providing anonymous notifications for residents of an assisted living facility.

FIG. 9 illustrates several examples of graphical user interfaces (GUI) of an anonymous ID follower application.

FIG. 10 illustrates an example of a survey graphical user interface (GUI).

Like reference symbols in the various drawings indicate like elements.

### DETAILED DESCRIPTION

An anonymous notification system may allow a first user of first computing device to electronically send status notifications to a select group of other users of additional computing devices without revealing any of the first user's personal identifying information. For example, an anonymous notification system may allow a healthcare facility (e.g., a hospital, doctor's office, nursing home, outpatient clinic, etc.) to send general status notification updates to friends and family of a patient without compromising the patient's privacy by revealing any of the patient's personal identifying information.

For instance, a patient, Mary, may be in labor and be admitted to a hospital for the birth of her first baby. Upon being admitted, Mary may wish to keep her close friends and family apprised of her status, however, she may not want to publicize the status of her labor excessively, such as over social media. The hospital may offer Mary the ability to use an anonymous patient status notification system to keep his close friends and family informed of his status. Hospital staff may request, via an anonymous notification system, a specific anonymous ID for Mary (e.g., ABCD1234). Mary, or Mary's husband Joe, can then provide her anonymous ID to Mary's close friends and family.

The friends and family can then register their computing devices with the anonymous notification system (e.g., via an anonymous ID follower application, e-mail address, phone number, etc.) to receive status notifications associated with Mary's anonymous ID (ABCD1234). As hospital staff update Mary's status, for example, in a hospital patient database, the anonymous notification system may use the status updates to generate status notifications to be sent to all of the computing devices registered to receive status notifications associated with Mary's anonymous ID. While the status notifications provide information about Mary's status, they do not include personally identifying information of Mary. So, as Mary's labor progresses her close friends and family will receive status notifications on their computing devices informing them of Mary's status, but others that do not know the anonymous ID is associated with Mary will likely not be able to connect the status information with Mary.

In another, more general example, a group of business colleagues may be planning a surprise retirement party for a retiring colleague, Dave. One of the colleagues, Bill, who is planning the party, may register (e.g., via a website or software application) with an anonymous notification system to keep all of the other colleagues informed about the status of the party and the whereabouts of Dave, preferably without tipping Dave off if he were to see a status notification. Upon registering, the anonymous notification system provides Bill with a unique anonymous ID (e.g., XYZ789) and a platform (e.g., a website or software application) for creating and sending notifications. The other colleagues may then register their computing devices with the anonymous notification system (e.g., via an anonymous ID follower application, e-mail address, phone number, etc.) to receive status notifications associated with Bill's anonymous ID (XYZ789). Bill may then send notifications regarding Dave's retirement party without concern that Dave will discover the party. For example, when Dave sends status update notifications to the other colleagues the notifications will not contain any personal identifying information linking them to Dave or the other colleague's. Furthermore, the notifications may be un-forwardable, therefore, making it more difficult for a particular colleague, who perhaps has a difficult time keeping secrets, from passing on the notifications electronically.

In general, anonymity may be provided by transmitting information within a system or among multiple systems in a manner such that the transmission does not include information which would personally identify a user associated with a user identifier (ID) (e.g., an anonymous user ID). That is, anonymity may be provided when the user ID itself and any messages, notifications, etc. transmitted within a system or among multiple systems in association with the user ID do not include personal identifying information related to the person associated with the user ID.

Personal identifying information generally includes information that may be used by itself or in combination with other information to identify a specific individual person or multiple persons associated with an anonymous user ID. Personal identifying information includes, for example, a person's name, social security number, birthdate, home address, a name of a healthcare facility in which a patient is treated, a name of an assisted living facility, or a patient's room number.

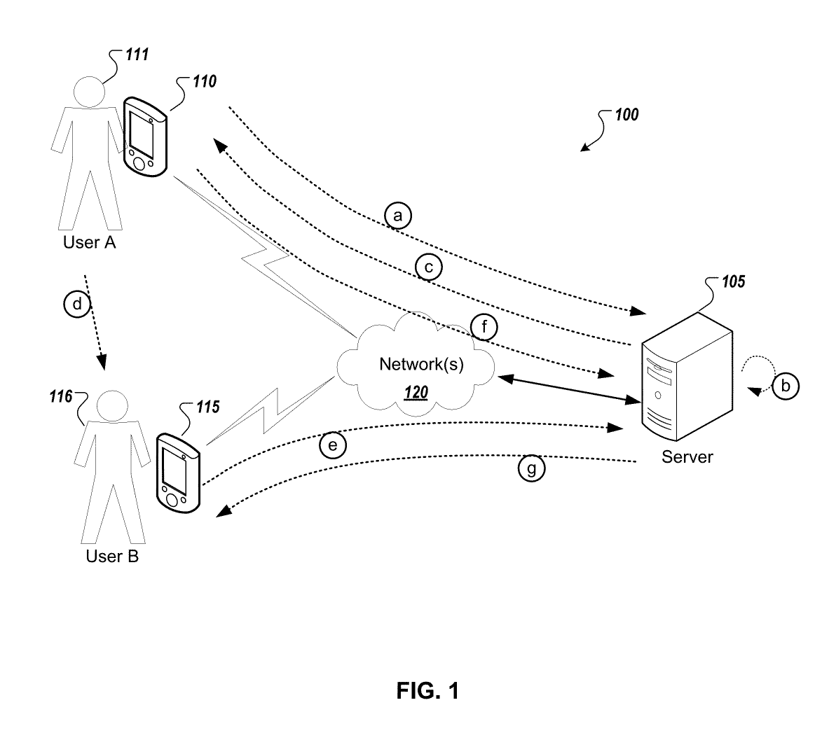

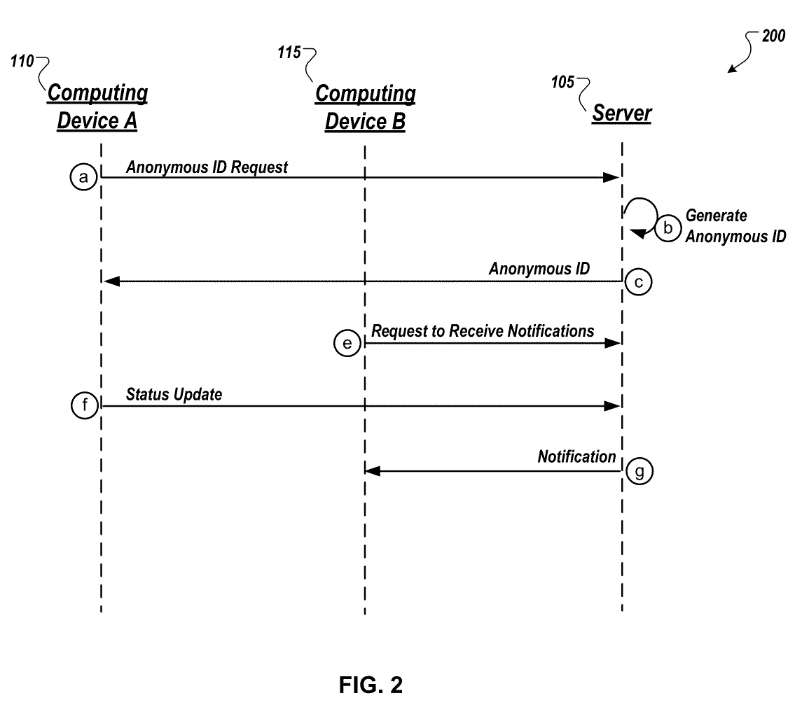

FIG. 1 is a diagram showing an example of a system 100 for providing anonymous status notifications. In addition, FIG. 1 is described in relation to FIG. 2 which is a swim lane diagram illustrating an exemplary anonymous notification process 200. FIGS. 1 and 2 together serve to illustrate the data flow within the system 100 during states (a) to (g). Briefly, the system 100 includes a server 105, computing devices 110 and 115 operated by user A 111 and user B 116 respectively, and network 120 over which the server 105 and computing devices 110 and 115 communicate.

In more detail, the system 100 represents an anonymous notification system. Server 105 may include one or more computer devices in communication with network 120. For example, server 105 may include a server or set of servers that are co-located with one another or geographically distributed. Server 105 also may include cloud-based or edge network equipment and services. Server 105 hosts appropriate software to manage the anonymous notification system (e.g., an anonymous notification management system). For example, the anonymous notification management system executing on server 105 may perform tasks, such as, generating anonymous IDs, registering computing devices (e.g., computing device 115) to receive anonymous notifications, receiving status updates (e.g., from computing devices such as computing device 110), and generating and transmitting anonymous notifications.

Computing devices 110 and 115 may be any of a number of different types of computing devices including, for example, mobile phones; smartphones; personal digital assistants; laptop, tablet, and netbook computers; and desktop computers including personal computers, special purpose computers, general purpose computers, and/or combinations of special purpose and general purpose computers. Each of the computing devices 110 and 115 typically may have internal or external storage components for storing data and programs such as an operating system and one or more application programs.

Network 120 may provide direct or indirect communication links between server 105 and computing devices 110 and 115. Examples of network 120 include, for example, the Internet, wide area networks (WANs), local area networks (LANs) including wireless LANs (WLANs), analog or digital wired and wireless telephone networks (e.g., 3G and 4G networks), and/or any other delivery mechanisms for carrying data.

The states (a) to (g) depict a data flow that occurs when the anonymous notification process 200 is performed by the system 100. During state (a) an anonymous ID request is sent (a) from computing device 110 to server 105. For example, user 111 (e.g., Bill who is planning the retirement party) may create an anonymous notification system user account via a website hosted at server 105. In addition or alternatively, user 111 (e.g., Bill) may request an anonymous ID via an anonymous notification system user application executed on computing device 110 and in communication with server 105. In response to receiving the request for an anonymous ID, during state (b), server 105 generates a random anonymous ID. An anonymous user ID may be, for example, a six to eight character, alphanumeric code. The code may represent, for example, a six to eight digit base thirty-six binary user ID.

During state (c), the server 105 sends the generated anonymous ID to computing device 110 for display to the user 111 (e.g., Bill). User 111 may then convey his anonymous user ID to user 116, state (d). For instance, Bill (i.e., user 111) may tell his anonymous ID only to other colleagues who are helping him plan the retirement party and/or who will be attending the party. Thus, Bill can strictly limit who knows his anonymous user ID and who will be able to receive anonymous notifications associated with his ID. Furthermore, the anonymous ID is not associated with any searchable user profile information that could potentially link Bill (i.e., user 111) to his anonymous user ID.

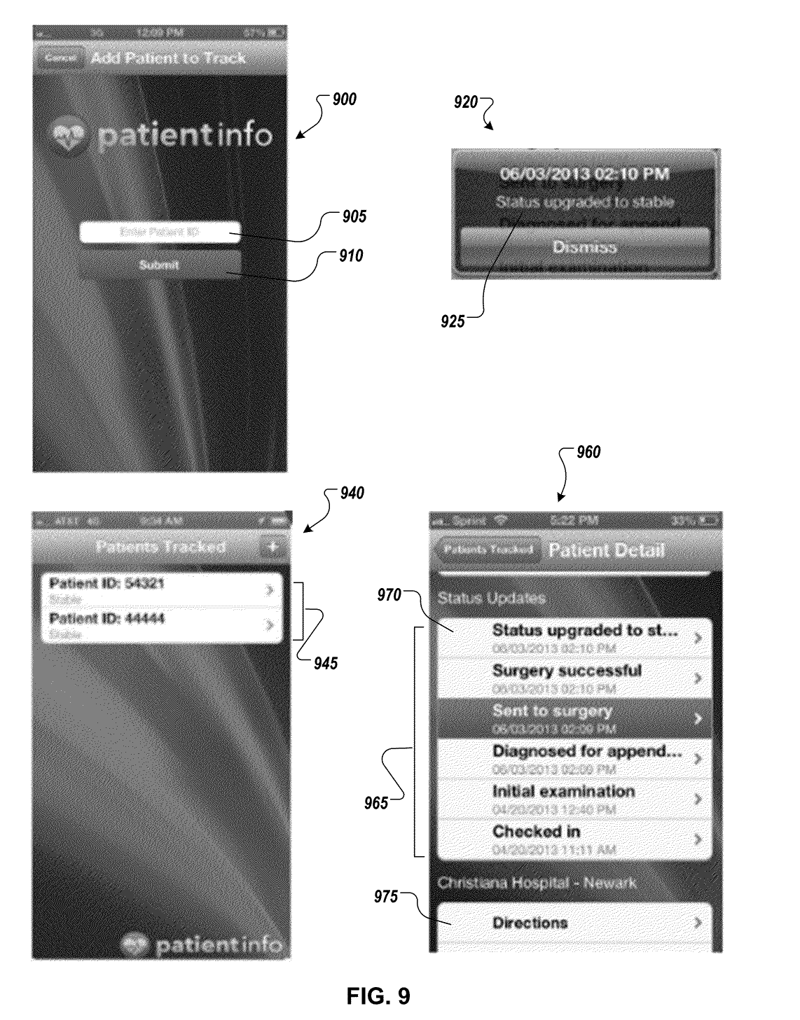

During state (e), computing device 115 sends a request to register with server 105 to receive anonymous notifications associated with Bill's (i.e., user 111) anonymous user ID. For example, user 116 may register with server 105 to receive status notifications, for example, via notifications sent to an anonymous ID follower application (described in more detail below in reference to FIG. 9), an e-mail address, or text messages. User 116 may register with server 105 to receive status notifications associated with Bill's (i.e., user 111) anonymous ID through a webpage hosted by server 105 or by downloading an anonymous ID follower application, for example. User 116 may be, for example, one of Bill's colleagues, Sara, who will be attending Dave's surprise retirement party.

During state (f), computing device 110 sends a status update to server 105. Server 105, during state (g), then generates an anonymous status notification based on the status update and sends the notification to computing device 115. For example, if Sara (i.e., user 116) registered computing device 115 with server 105 to receive notifications via text message, then server 105 would correctly format the received status update to be transmitted as a text message. Similarly, if Sara (i.e., user 116) registered computing device 115 with server 105 to receive notifications via an anonymous ID follower application executing on computing device 115, then server 105 would correctly format the received status update to be transmitted as a notification to the anonymous ID follower application. Furthermore, server 105 may push notifications to one or more computing devices registered to follow a particular anonymous ID (e.g., using Apple Push Notification Service, Google Cloud Messaging, or other appropriate push notification protocols). In addition or alternatively, server 105 may temporarily store notifications associated with an anonymous user ID and transmit the notifications to registered computing devices in response to pull requests from each registered device.

In some implementations, server 105 includes one or more databases for storing active anonymous user IDs and information related to computing devices registered to receive notifications associated with each active anonymous user ID. Furthermore, all anonymous user IDs, registered computing devices, and associated login information (e.g., passwords) may be encrypted to ensure user privacy and anonymity.

For instance, anonymous user IDs may be stored using a one-way salted SHA-256 hashing algorithm. The SHA-256 hashing algorithm is part of the SHA-2 family of hashing algorithms. The SHA-256 hashing algorithm takes a string of characters of any length and converts the string into a unique, irreversible string of characters. Thus, anonymous user IDs are stored in indecipherable strings of characters. In addition, salting includes adding an additional string of characters to the algorithm, making each individual users result different every other result produced by the algorithm, even if given the character string is input to the algorithm. Accordingly if access to the database is breached, the breaching party will not be able to determine the personal identity of each user associated with each anonymous user ID.

Data associated with computing devices registered to receive notifications associated with one or more anonymous IDs, may be stored, for example, using a key based encryption algorithm, such as AES-256. Such data may include, for example, a phone number, a user's e-mail address, a media access control (MAC) address, and/or other data identifying the second device or a user of the second device. And passwords associated with user accounts associated with anonymous ID accounts and/or devices registered to receive notifications may be stored using, for example, an adaptive password hashing algorithm, such as bcrypt.

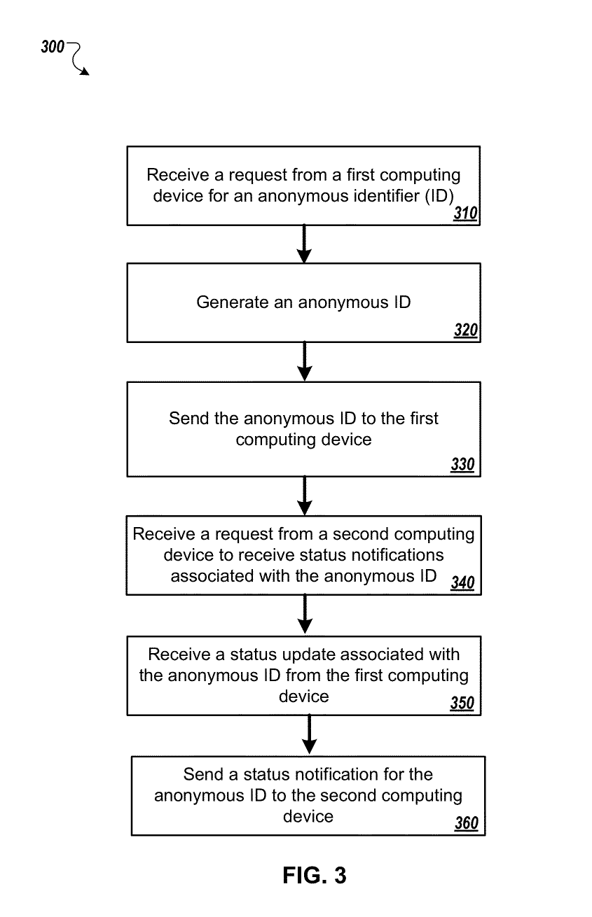

FIG. 3 is a flowchart showing an example of a process 300 for providing anonymous notifications. The process 300 may be implemented, for example, by an anonymous notification management system hosted by a server, such as server 105 of FIGS. 1 and 2. Briefly, the process 300 includes receiving a request from a first computing device for an anonymous identifier (ID), generating an anonymous ID, sending the anonymous ID to the first computing device, receiving a request from a second computing device to receive status notifications associated with the anonymous ID, receiving a status update associated with the anonymous ID from the first computing device, and sending a status notification for the anonymous ID to the second computing device.

In more detail, when process 300 begins a request for an anonymous identifier (ID) sent from a computing device (e.g., computing device 110 of FIGS. 1 and 2) is received at a server (e.g., server 105 of FIGS. 1 and 2) (310). The request may include, for example, a request to open an anonymous identification system user account. For instance, the anonymous notification management system may include a web-based user interface. Alternatively or in addition, the request may include a request to download and/or register an anonymous notification system user application with the anonymous notification management system.

The anonymous notification management system generates an anonymous ID in response to the request for an anonymous ID and sends the anonymous ID to the first computing device (320). An anonymous user ID may be a six to eight character, alphanumeric code, however, longer or shorter character lengths may be used depending on the application or level of security desired. The code may represent, for example, a six to eight digit base thirty-six binary user ID.

The anonymous notification management system receives a request to receive status notifications associated with the anonymous ID from a second computing device (e.g., computing device 115 of FIGS. 1 and 2) (330). The request may include, for example, a request to open an anonymous identification system follower account. As described above, for instance, the anonymous notification management system may include a web-based user interface which allows someone who wishes to receive anonymous notification updates to register one or more computing devices to receive notifications (e.g., via text messages, e-mails, etc.). Alternatively or in addition, the request may include a request to download and/or register an anonymous ID follower application with the anonymous notification management system, thereby, allowing a user to receive anonymous notification updates associated with one or more anonymous ID's. In some implementations, an anonymous notification system user application and an anonymous ID follower application may be one application which supports both functions. An example of an anonymous ID follower application is described in connection with FIG. 9 below. In some implementations, a user of the second computing device may be permitted to register to receive anonymous notifications via multiple notification methods, for example, a user may register to receive anonymous notifications via both e-mail and an anonymous ID follower application.

The anonymous notification management system receives a status update associated with the anonymous ID from the first computing device 110 (340). The status update may be received from the first computing device 110 through a user account accessible via a web-based user interface, for instance. Alternatively or in addition, the request may be received from the first computing device 110 through an anonymous notification system user application executing on the first computing device. For example, the anonymous notification system user application may allow a user to select from a predefined menu of status updates which do not include any personal identifying information or to enter a customized status update. In addition, the anonymous notification management system or the anonymous notification system user application may screen customized status updates for personal identifying information and warn a user that submitting the customized status update may compromise the anonymity of the user's anonymous ID. The anonymous notification management system or anonymous notification system user application may then allow the user to select whether to allow the anonymous notification management system to remove the personal identifying information, to submit the status update anyway, to edit the status update prior to submission.

Finally the anonymous notification management system sends a status notification for the anonymous ID to the second computing device 115 based on the status update (350). The status notification may be sent to the second computing device 115 via any and all methods requested by the second computing device 115 either when the user of the second computing device registered to receive anonymous notifications or as altered by the user at a later time. The anonymous notification management system generates the appropriate notification (e.g., text message, e-mail, or anonymous ID follower application notification) and sends the notification to the second device 115. In addition, the anonymous notification management system may remove any personal identifying information from the received status update such that the notification includes only non-personal identifying information, thereby, ensuring the anonymity of the first computing device 110 user's 111 anonymous ID. In some implementations, as described above, the anonymous notification management system or the anonymous notification system user application may have warned the user of the first computing device that a customized status update included personal identifying information. In such an implementation, if the user 111 of the first computing device 110 selected to send the update anyway the anonymous notification management system may not remove the personal identifying information.

The anonymous notification management system may send notifications to the second computing device via either push or pull protocols or both. For example, the anonymous notification management system may push notifications to one or more computing devices registered to follow a particular anonymous ID (e.g., using Apple Push Notification Service, Google Cloud Messaging, or other appropriate push notification protocols). In addition or alternatively, the anonymous notification management system may temporarily store notifications associated with an anonymous user ID and transmit the notifications to registered computing devices in response to pull requests from each registered computing device.

In some implementations, anonymous notifications may not be forwardable. That is, a user of the second computing device 115 may be prevented from forwarding any anonymous notification sent to the second computing device. For example, the anonymous ID follower application may not allow a user to copy and paste text from notifications sent to the second computing device via an anonymous ID follower application. Furthermore, the anonymous notification management system may permit an owner of an anonymous ID to limit the delivery methods that users who register to receive notifications associated with his/her anonymous ID may choose. For example, the anonymous ID owner may only permit those who register to receive notifications associated with his/her anonymous ID to receive anonymous notifications via an anonymous ID follower application, thereby, deterring such registrants from forwarding notifications to people who the owner does not wish to receive such notifications.

In another aspect, the anonymous notification system 100 described above in reference to FIGS. 1-3 may be adapted for use by a healthcare facility (e.g., a hospital, doctor's office, outpatient clinic, etc.). In such an implementation, the anonymous notification system 100 may be integrated into a healthcare facility's patient information system. Such an implementation may be advantageous in a situation such as that described above related to Mary being admitted to a hospital to give birth. Recall that, by way of example, a patient, Mary, may be in labor and be admitted to a hospital for the birth of her first baby. Upon being admitted, Mary may wish to keep her close friends and family apprised of her status, however, she may not want to publicize the status of her labor excessively, such as over social media. The hospital may offer Mary the ability to use an anonymous patient status notification system to keep his close friends and family informed of his status. Hospital staff may request, via an anonymous notification system, a specific anonymous ID for Mary. Mary, or Mary's husband Joe, for example, can then provide her anonymous ID to Mary's close friends and family.

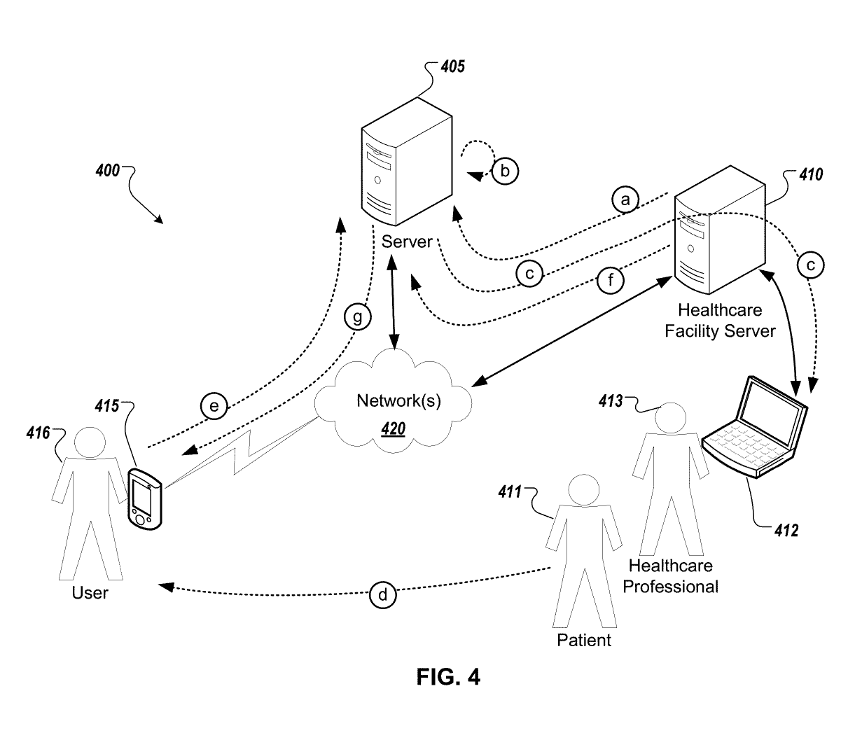

FIG. 4 illustrates an example of such an implementation in more detail. FIG. 4 is a diagram showing an example of a system 400 for providing anonymous status notifications integrated with a healthcare facility patient information system. In addition, FIG. 4 illustrates the data flow within the system 400 during states (a) to (g). Briefly, the system 100 includes a server 405, healthcare patient information system server 410, computing device 412 operated by healthcare professional 413, computing device 416 operated by user 416, and network 420 over which the servers 405 and 410, and computing devices 410 and 415 communicate.

In more detail, the system 400 represents a healthcare facility integrated anonymous notification system. Servers 405 and 410 may include any one or more computer devices in communication with network 420. For example, servers 405 and 410 may include a server or set of servers that are co-located with one another or geographically distributed. Servers 405 and 410 also may include cloud-based or edge network equipment and services. Components of the anonymous notification system may reside on each of servers 405 and 410. For example, server 405 may host appropriate software to manage the anonymous notification system (e.g., a notification component of an anonymous notification management system) and server 410 may host appropriate software to manage patient anonymous IDs and to request status update notifications (e.g., a healthcare component an anonymous notification management system). The component executing on server 405 may perform tasks, such as, generating anonymous IDs, registering computing devices (e.g., computing device 115) to receive anonymous notifications, receiving status updates (e.g., from computing devices such as healthcare facility server 410), and generating and transmitting anonymous notifications. The component executing on server 410 may perform tasks, such as, identifying an anonymous identifier (ID) associated with a patient at a health-care facility, identifying data indicating a medical status update for the patient has been received by the healthcare facility server, and sending a request to server 405 to send a medical status notification about the patient to a computing device that is registered to receive notifications associated with the anonymous ID

Healthcare facility server 410 may host a patient information system (e.g., an EPIC software system) and may be in communication with computing device 412 through a secure network, for example, through local area network (LAN) or over network 420 via a virtual private network (VPN). The patient information system tracks the status of patients at the healthcare facility and may be updated by healthcare professionals 413 (e.g., physicians, nurses, and administration staff). In addition, the patient information system may use a standardized patient information tracking system such as, for example, Health Level Seven International (HL7), which is a not-for-profit, ANSI-accredited standard. The HL7 standard includes a standardized list of patient status events (found in the Health Level Seven, Version 2.7 Standard, January 2011 which is incorporated herein by reference in its entirety), which may be used to generate anonymous notifications related to a particular patient's treatment status. For clarity patient information system events will be described in reference to HL7 events, however, other applicable standard patient status code formats may be used, for example, IC9 and IC10 (or ICD-9 and ICD-10).

Computing devices 412 and 415 may be any of a number of different types of computing devices including, for example, mobile phones; smartphones; personal digital assistants; laptop, tablet, and netbook computers; and desktop computers including personal computers, special purpose computers, general purpose computers, and/or combinations of special purpose and general purpose computers. Each of the computing devices 412 and 415 typically may have internal or external storage components for storing data and programs such as an operating system and one or more application programs.

Network 420 may provide direct or indirect communication links between server 405 and computing devices 412 and 415. Examples of network 420 include, for example, the Internet, wide area networks (WANs), local area networks (LANs) including wireless LANs (WLANs), analog or digital wired and wireless telephone networks (e.g., 3G and 4G networks), and/or any other delivery mechanisms for carrying data.

The states (a) to (g) depict a data flow that occurs when an example anonymous notification process is performed by the system 400. During state (a) an anonymous ID request is sent from healthcare facility server 410 to server 405. For example, healthcare professional 413 may admit patient 411 (e.g., Mary) to the healthcare facility, for instance, by registering her as a patient in the healthcare facility's patient information system. The health care worker 413 may make appropriate administrative entries via computing device 412 which will transmit the appropriate data to healthcare facility server 410. Upon receiving the patient admission data the patient information system may request an anonymous ID for patient 411 e.g., Mary) from server 405. In addition or alternatively, healthcare facility server 410 may have previously been assigned a block of anonymous IDs by server 405 and healthcare facility server 410 may simply assign an unused anonymous ID to patient 411 (e.g., Mary).

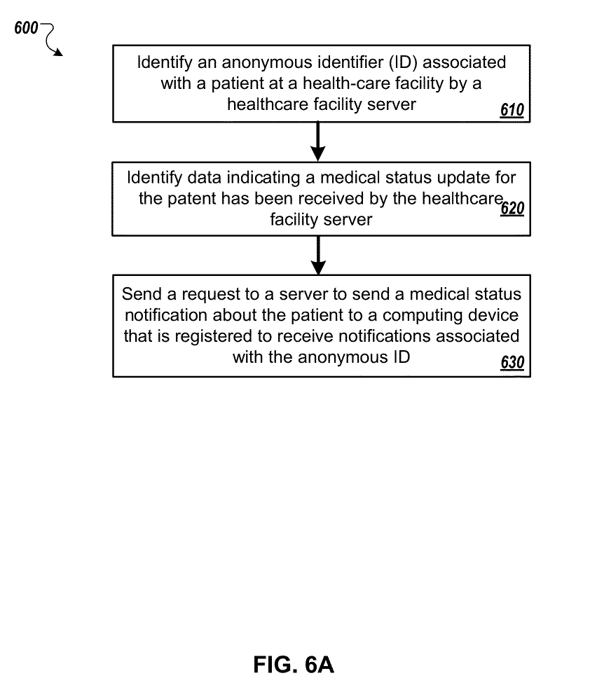

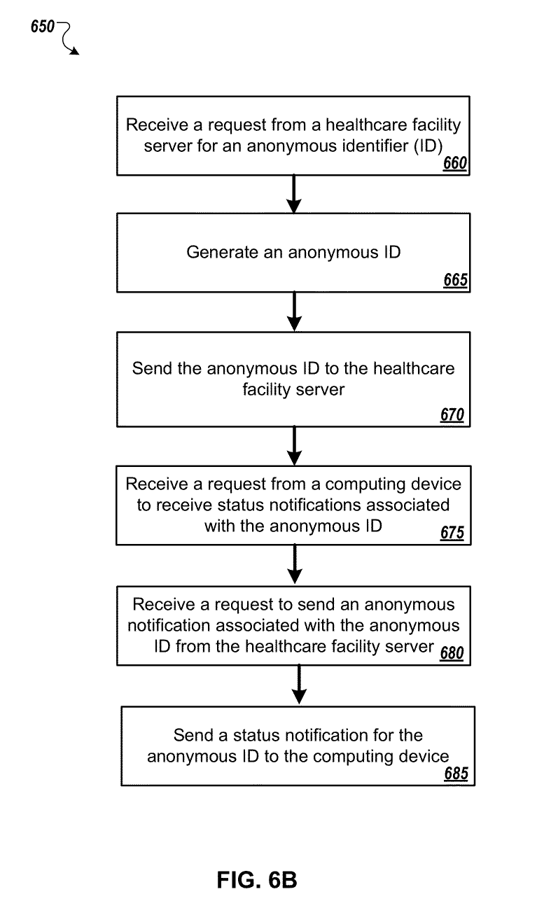

In response to receiving the request for an anonymous ID, during state (b), server 405 generates a random anonymous ID. (Anonymous ID generation is descried in more detail in reference to FIG. 6 below.) An anonymous ID may be a six to eight character, alphanumeric code. The code may represent, for example, a six to eight digit base thirty-six binary user ID.

During state (c), the server 405 sends the generated anonymous user ID to healthcare facility server 410 which assigns the anonymous ID to patient 411 (e.g., Mary). Healthcare professional 413 may view the anonymous ID on computing device 412 and inform patient 411 of the anonymous ID that has been assigned to her. Patient 411 may then convey her anonymous ID to user 416, state (d). For instance, Mary (i.e., user 411), or her husband, may tell her anonymous ID only to friends and family who she wishes to keep apprised of her labor. Thus, Mary can strictly limit who knows her anonymous ID and who will be able to receive anonymous notifications associated with her ID. Furthermore, the anonymous ID is not associated with any searchable user profile information that could potentially link Mary (i.e., patient 411) to her anonymous ID.

During state (e), computing device 415 sends a request to register with server 405 to receive anonymous notifications associated with Mary's (i.e., patient 411) anonymous ID. For example, user 416 (e.g., Mary's sister) may register with server 405 to receive status notifications, for example, via notifications sent to an anonymous ID follower application (described in more detail below in reference to FIG. 9), an e-mail address, or text messages. User 416 may register with server 405 to receive status notifications associated with Mary's (i.e., patient 411) anonymous ID through a webpage hosted by server 405 or by downloading an anonymous ID follower application, for example.

During state (f), healthcare facility server 410 receives a status update for patient 411 which triggers a corresponding HL7 event. Upon receiving the HL7 event the patient information system sends a status update to server 405 based on the HL7 event. For example, the HL7 event may indicate that Mary has received an initial examination, that Mary has given birth to a baby girl, or that Mary has been moved from the delivery room to a recovery room. The patient information system may send a textual description of the HL7 event to server 405 or the data representing the HL7 event, which may be converted to a textual description by server 405.

Server 405, during state (g), then generates an anonymous status notification based on the status update (or HL7 event) and sends the notification to computing device 415. The anonymous status notifications do not contain any personally identifying information about a patient, therefore, making it unlikely that someone who does not know a particular patient's anonymous ID will be able to connect information contained in a notifications to the patient. For example, if Mary's sister (i.e., user 416) registered computing device 415 with server 405 to receive notifications via text message, then server 405 would correctly format the received status update to be transmitted as a text message. For example, Mary's sister might receive a text message stating, “Gave birth to a baby girl.” Similarly, if Mary's sister (i.e., user 416) registered computing device 415 with server 405 to receive notifications via an anonymous ID follower application executing on computing device 415, then server 405 would correctly format the received status update to be transmitted as a notification to the anonymous ID follower application. While the status notifications provide information about Mary's status, they do not include personally identifying information of Mary. So, as Mary's labor progresses her sister, for example, will receive status notifications on her computing devices informing her of Mary's status, but others that do not know the anonymous ID is associated with Mary will likely not be able to connect the status information with Mary

Furthermore, server 405 may push notifications to one or more computing devices registered to follow a particular anonymous ID (e.g., using Apple Push Notification Service, Google Cloud Messaging, or other appropriate push notification protocols). In addition or alternatively, server 405 may store a temporarily store notifications associated with an anonymous user ID and transmit the notifications to registered computing devices in response to pull requests from each registered device.

In some implementations, server 405 includes one or more databases for storing active anonymous user IDs and information related to computing devices registered to receive notifications associated with each active anonymous user ID. Furthermore, all anonymous user IDs, registered computing devices, and associated login information (e.g., passwords) may be encrypted to ensure user privacy and anonymity.

For instance, anonymous user IDs may be stored using a one-way salted SHA-256 hashing algorithm. The SHA-256 hashing algorithm is part of the SHA-2 family of hashing algorithms. The SHA-256 hashing algorithm takes a string of characters of any length and converts the string into a unique, irreversible string of characters. Thus, anonymous user IDs are stored in indecipherable strings of characters. In addition, salting includes adding an additional string of characters to the algorithm, making each individual users result different every other result produced by the algorithm, even if given the character string is input to the algorithm. Accordingly if access to the database is breached, the breaching party will not be able to determine the personal identity of each user associated with each anonymous user ID.

Data associated with computing devices registered to receive notifications associated with one or more anonymous IDs, may be stored, for example, using a key based encryption algorithm, such as AES-256. Such data may include, for example, a phone number, a user's e-mail address, a media access control (MAC) address, and/or other data identifying the second device or a user of the second device. And passwords associated with user accounts associated with anonymous ID accounts and/or devices registered to receive notifications may be stored using, for example, an adaptive password hashing algorithm, such as bcrypt.

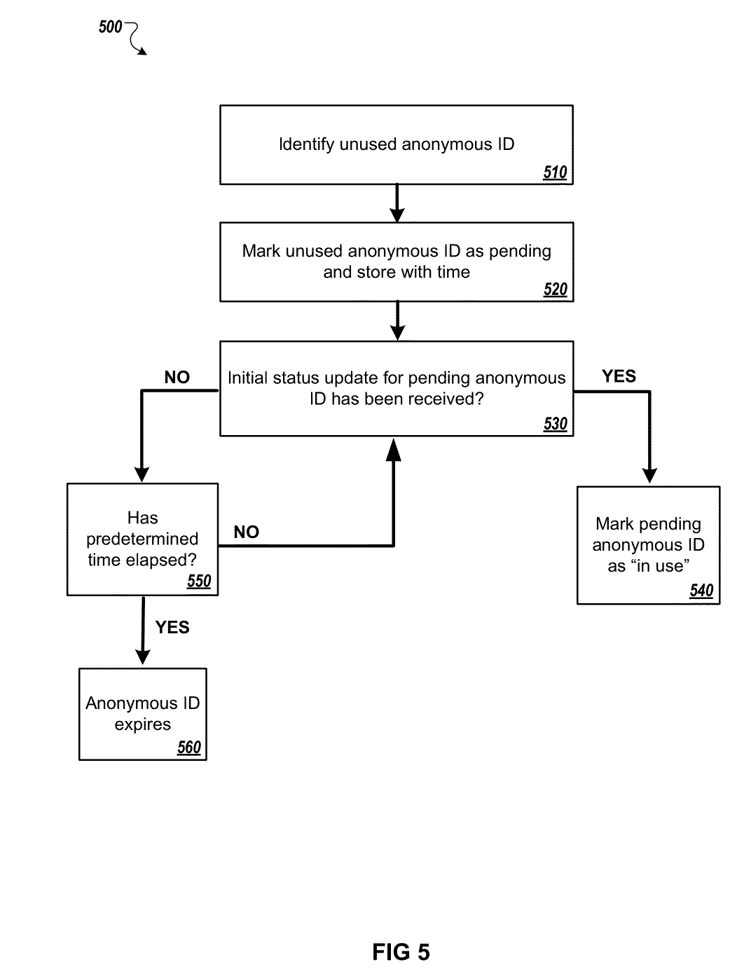

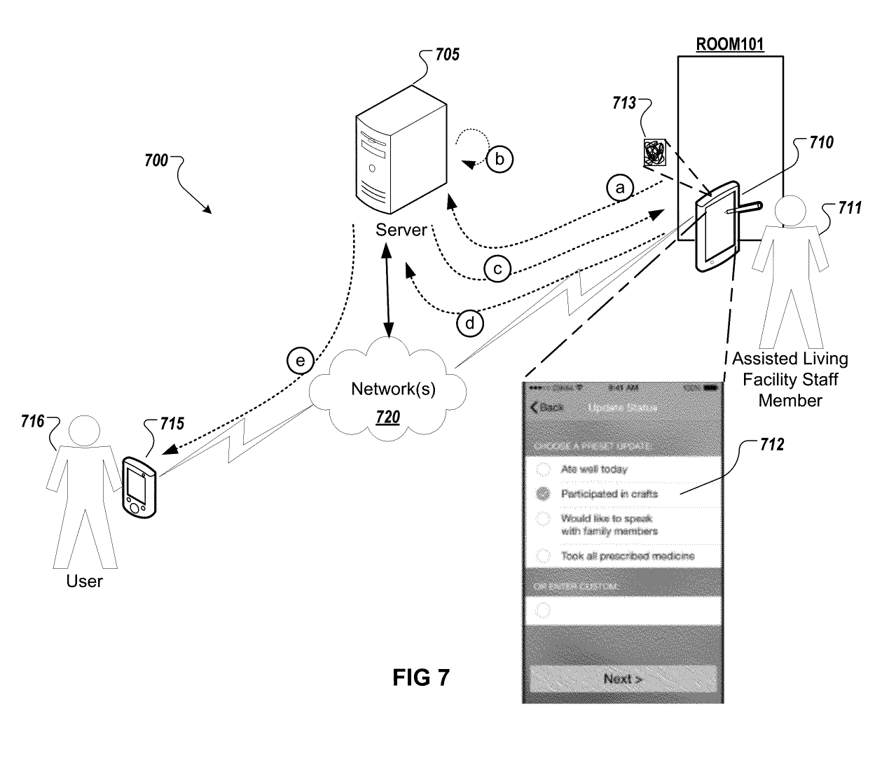

FIG. 5 is a flowchart showing an example of a process 500 for generating anonymous IDs. The process 500 may be implemented, for example, by an anonymous notification management system hosted by a server, such as server 405 of FIG. 4. Although process 500 is described in reference to server 405 of FIG. 4, a similar process may be performed by either server 105 of FIG. 1 described above or server 705 of FIG. 7 described below.

Initially upon receiving an anonymous ID request, the anonymous notification management system operating on server 405 identifies an unused anonymous ID (510). An unused anonymous ID may be one that has not yet been assigned to a user. The anonymous notification management system may, for example, retain a list of all possible anonymous IDs and store data that indicates whether each ID is in use in association with the IDs. Alternatively, the anonymous notification management system may, for example, randomly generate an anonymous ID in response to each request for a new ID and then verify that the randomly generated ID is not already in use. In some implementations, the anonymous notification management system may incorporate both of the previously described methods. For instance, the anonymous notification management system may generate anonymous IDs in batches, marking each ID as used as it is issued and generating a new batch of IDs once all or nearly all of the anonymous IDs of the previous batch are used.

Once the anonymous notification management system identifies the anonymous ID, the anonymous notification management system then marks that anonymous ID as pending and stores data representing a time of the anonymous ID request in association with the marked anonymous ID (520). That is, once identified by the anonymous notification management system, the anonymous ID may be reserved for a defined period of time, for example ten to thirty minutes to ensure that the anonymous ID request is valid and that the anonymous ID will in-fact be used. In addition, the anonymous notification management system sends the anonymous ID back to healthcare facility server 410.

Next, the anonymous notification management system determines whether an initial status update (e.g., an HL7 event) has been received for the pending anonymous ID (530). Reception of a status update associated with the pending anonymous ID may server as an indication that the received anonymous ID request is valid and confirm that the requested anonymous ID will be used. If a status update has been received, the anonymous notification management system then marks the pending anonymous ID as in use (540). That is, the anonymous notification management system stores data indicating that the anonymous ID is in use in association with the anonymous ID. On the other hand, if the server 405 has not received a status update for the pending anonymous ID, then the anonymous notification management system may determine whether a predetermined amount of time has elapsed since receiving the request for the pending anonymous ID (550). For instance, the anonymous notification management system may compare the time data that was stored in association with the pending anonymous ID when the anonymous ID request was received with a clock at the server 405. If the predetermined time period elapses and no status update is received for the pending anonymous ID, then the anonymous notification management system may remove the pending status marker from the anonymous ID (560), thereby, making the anonymous ID available for use with another, subsequent, anonymous ID request.

In some implementations, the anonymous notification management system may continue to perform a similar process for anonymous IDs that are in use. For example, anonymous notification management system may reset the time data stored in association with an in use anonymous ID every time a new status update is received for the ID. The anonymous notification management system may then compare the time data associated with the in use anonymous ID with another predetermined time period (e.g., an “in use” predetermined time period) and if the in use anonymous ID remains inactive (e.g., no status updates are received for the in use anonymous ID within the “in use” predetermined time period), then the in use indicator may be removed from the anonymous ID and the anonymous ID may be made available for another use. In such a way, inactive anonymous IDs may be reclaimed for other uses. For example, an anonymous ID may be assigned to a patient by stay, rather than by patient, where a “stay” is understood to include the period of time that a patient resides in the healthcare facility (i.e., the time from admittance to discharge). In addition, the patient ID may remain active for some useful period of time following discharge, for example several hours or days. In this example, if the same patient is admitted to a healthcare facility at a later date (either the same or a different healthcare facility), then a new anonymous ID would be assigned to that patient for the new stay.

In another implementation, if a patient is “re-admitted” to the same healthcare facility or different healthcare facility within the in use predetermined time period, that patient may be re-assigned the same anonymous ID as a previous stay. In this regard, re-admittance is understood to be some period of time that may be defined by the healthcare facility or by regulation, or otherwise. For example, the Mayo Clinic defines hospital readmission as patient admission to a hospital within 30 days after being discharged from an earlier hospital stay. In addition, the standard benchmark used by the Centers for Medicare & Medicaid Services (CMS) is also the 30-day readmission rate. Furthermore, rates at the 80th percentile or lower are considered optimal by CMS. (http://www.mayoclinic.org/about-mayo-clinic/quality/quality-measures/readmission-rates) As a particular example, if a patient returns to the same healthcare facility within a given period of time; or for the same cause, diagnosis, and/or symptoms as the earlier admittance; or some combination of time period and reason for return to the healthcare facility; then such a return to the healthcare facility may be deemed a “re-admittance.” In such a case, the patient may receive the same anonymous ID as previously assigned.

In other implementations, an anonymous ID may be re-used for a same patient for any subsequent stay at the same healthcare facility, but a different patient ID used where the patient is admitted to a second healthcare facility. Alternatively, an anonymous ID may be re-used for a given patient for subsequent stays in any healthcare facility.

Re-use of a given anonymous ID may depend on whether it is associated with personal identifying information. In some implementations, no personal or other identifying information regarding any patient is provided to the server 405. In such cases, the same anonymous ID would not be automatically assigned to a given patient upon re-admittance or upon a subsequent visit to the same or a different healthcare facility. In such an implementation, for example, server 405 may permit the patient to provide a previously-assigned anonymous ID, and that anonymous ID may be re-utilized for the stay, provided that it has not been reassigned for another use. Alternatively, a patient's personal identifying information may be correlated anywhere within an anonymous notification system (e.g., system 400), including, for example, either server 405 or the healthcare facility server 410, or may be accessible from a separate system. In such an implementation, for example, the patient may be assigned the same anonymous ID automatically; or if a new anonymous ID is assigned, then multiple anonymous ID's associated with that patient may be correlated, so that data from multiple stays can be associated with a single patient.

FIG. 6A is a flowchart showing an example of a process 600 for providing anonymous notifications for a patient at a healthcare facility. The process 600 may be implemented by, for example, by a component of an anonymous notification management system hosted by a server, such as server 410 of FIG. 4. Briefly, the process 600 includes identifying an anonymous identifier (ID) associated with a patient at a health-care facility by a healthcare facility server, identifying data indicating a medical status update for the patent has been received by the healthcare facility server, and sending a request to a server to send a medical status notification about the patient to a computing device that is registered to receive notifications associated with the anonymous ID.

In more detail, when process 600 begins, an anonymous notification management system identifies an anonymous identifier (ID) associated with a patient at a health-care facility (610). For example, an anonymous notification management system may be hosted on a healthcare facility server (e.g., healthcare facility server 410) and integrated with the healthcare facility's patient information system. The anonymous notification management system may be configured to assign anonymous ID's to patients who request that anonymous notifications be sent to family and friends to keep them appraised of the patient's medical status. The anonymous notification management system may request one or more anonymous IDs from an anonymous notification system server (e.g., server 405). In response to such a request the anonymous notification system server may generate and send anonymous ID(s) to the healthcare facility server according to the process described in conjunction with FIG. 5 above.

The anonymous notification management system identifies data indicating a medical status update for the patent has been received by the healthcare facility server (620). The anonymous notification management system may monitor the healthcare facility's patient information system for medical status updates associated with a patient who has been assigned an anonymous ID. The medical status updates may include standardized patient information tracking system events, such as HL7 events (as described above).

In response to identifying that the data indicating the medical status update for the patient has been received, the anonymous notification management system may send a request to an anonymous notification system server 405 to send a medical status notification about the patient to a computing device (e.g., computing device 415 of FIG. 4) that is registered to receive notifications associated with the patient's anonymous ID (630). The request may include, for example, the patient's anonymous ID and the medical status update for the patient (or data representing the medical status update).

The anonymous notifications system server receives the request and sends a status notification to a computing device 415 that is registered with the anonymous notification server to receive notifications associated with the patient's anonymous ID. The status update may be sent to the registered computing device 415 via any and all methods requested by the user of the registered computing device, for example, either when the user of the computing device 415 registered to receive anonymous notifications or as altered by the user at a later time. The anonymous notification system server generates the appropriate notification (e.g., text message, e-mail, or anonymous ID follower application notification) and sends the notification to the registered computing device 415. In addition, the anonymous notification system server generates the notification based on the medical status update, and therefore, the notification includes only non-patient identifiable information.

FIG. 6B is a flowchart showing an example of a process 650 for providing anonymous notifications for a patient at a healthcare facility. The process 650 may be implemented by, for example, by a component of an anonymous notification management system hosted by a server, such as anonymous notification system server 405 of FIG. 4. Briefly, the process 650 includes receiving a request from a healthcare facility server for an anonymous identifier (ID), generating an anonymous ID, sending the anonymous ID to the healthcare facility server, receiving a request from a computing device to receive status notifications associated with the anonymous ID, receiving a request to send an anonymous notification associated with the anonymous ID from the healthcare facility server, and sending a status notification for the anonymous ID to the computing device.

In more detail, when process 650 begins a request for an anonymous identifier (ID) from a healthcare facility server (e.g., server 410 of FIG. 4) is received at a server (e.g., anonymous notification system server 405 of FIG. 4) (660). The healthcare facility server 410 may request a single anonymous ID at a time to assign to each patient upon admission or the healthcare facility server 410 may manage allocation of anonymous ID's to patients and request a set of anonymous IDs.

The anonymous notification management system generates an anonymous ID (665) in response to the request for an anonymous ID (e.g., as described above in reference to FIG. 5) and sends the anonymous ID to the healthcare facility server 410 (670). An anonymous user ID may be a six to eight character, alphanumeric code, however, longer or shorter character lengths may be used depending on the application or level of security desired. The code may represent, for example, a six to eight digit base thirty-six binary user ID.

The anonymous notification management system receives a request to receive status notifications associated with the anonymous ID from a computing device (e.g., computing device 415 of FIG. 4) (675). The request may include, for example, a request to open an anonymous identification system follower account. As described above, for instance, the anonymous notification management system may include a web-based user interface which allows someone who wishes to receive anonymous notification updates to register one or more computing devices to receive notifications (e.g., via text messages, e-mails, etc.). Alternatively or in addition, the request may include a request to download and/or register an anonymous ID follower application with the anonymous notification management system, thereby, allowing a user to receive anonymous notification updates associated with one or more anonymous ID's. In some implementations, an anonymous notification system user application and an anonymous ID follower application may be one application which supports both functions. An example of an anonymous ID follower application is described in connection with FIG. 9 below. In some implementations, a user of the computing device 415 may be permitted to register to receive anonymous notifications via multiple notification methods, for example, a user may register to receive anonymous notifications via both e-mail and an anonymous ID follower application.

The anonymous notification management system receives a request to send an anonymous notification associated with the anonymous ID from the healthcare facility server 410 (680). The request may include the text of an anonymous notification or a patient status code (e.g., an HL7 code) which must be converted to appropriate text for a notification. For example, the request may include the text “Delivery Successful—It's a Girl.” In addition or alternatively, the request may include an appropriate HL7 code indicating that a patient had a successful delivery and the sex of the baby, which the server 405 then converts to appropriate text.

Finally the anonymous notification management system sends a status notification for the anonymous ID to the computing device 415 based on the status update (685). The status notification may be sent to the computing device 415 via any and all methods requested by the second computing device 415 either when the user of the second computing device registered to receive anonymous notifications or as altered by the user at a later time. The anonymous notification management system generates the appropriate notification (e.g., text message, e-mail, or anonymous ID follower application notification) and sends the notification to the second device 415. In addition, the anonymous notification management system may remove any personal identifying information from the received status update such that the notification includes only non-personal identifying information, thereby, ensuring the anonymity of the first computing device 410 user's 411 anonymous ID. In some implementations, as described above, the anonymous notification management system or the anonymous notification system user application may have warned the user of the first computing device that a customized status update included personal identifying information. In such an implementation, if the user 411 of the first computing device 410 selected to send the update anyway the anonymous notification management system may not remove the personal identifying information.

The anonymous notification management system may send notifications to the computing device 415 via either push or pull protocols or both. For example, the anonymous notification management system may push notifications to one or more computing devices registered to follow a particular anonymous ID (e.g., using Apple Push Notification Service, Google Cloud Messaging, or other appropriate push notification protocols). In addition or alternatively, the anonymous notification management system may temporarily store notifications associated with an anonymous user ID and transmit the notifications to registered computing devices in response to pull requests from each registered computing device

In some implementations, the anonymous notification management system may not request that an anonymous notification system server send notifications for every medical status updated, but only for predetermined medical status updates. Thus, the anonymous notification management system may distinguish between medical status updates that may be relevant to family and friends of a patient and those that are may not.

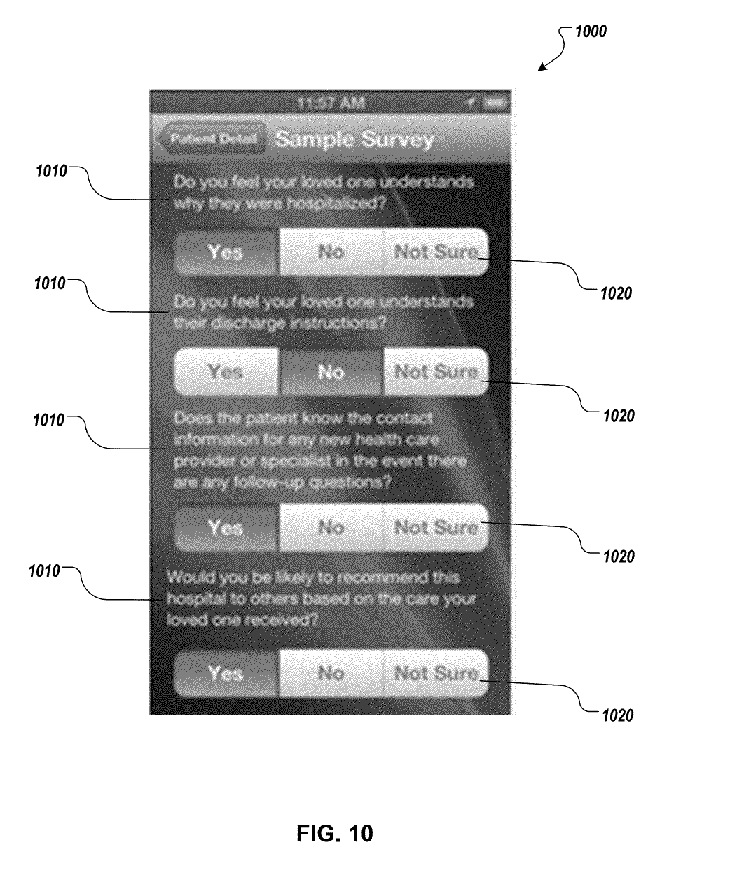

In some implementations, the notification may include a survey (e.g., such as one described below in reference to FIG. 10). A survey may be sent periodically (e.g., monthly, semi-annually, annually, etc.) or the sending a survey may be triggered by a particular patient status code (e.g., an HL7 patient discharge code). The survey may be generated by either the healthcare facility server 410 (and included in a request to send a notification) or by the anonymous notification system server 405 (and sent in response to either request to send a survey, a particular patient status code, or both).

In some implementations, the anonymous notification management system includes a calendaring function whereby a user (e.g., a healthcare professional) may suggest optimal visiting hours and/or block off times when visiting is discouraged and request that a notification indicating the optimal and/or discouraged visiting hours be sent to the patient's family and friends (e.g., people who have registered to receive notifications associated with the patient's anonymous ID).

In some implementations, anonymous notifications may not be forwardable. That is, a user of the second computing device may be prevented from forwarding any anonymous notification sent to the second computing device. For example, the anonymous ID follower application may not allow a user to copy and paste text from notifications sent to the computing device 415 via an anonymous ID follower application. Furthermore, the anonymous notification system server may permit an owner of an anonymous ID to select limit the delivery methods that users who register to receive notifications associated with his/her anonymous ID may choose. For example, the anonymous ID owner may only permit those who register to receive notifications associated with his/her anonymous ID to receive anonymous notifications via an anonymous ID follower application, thereby, deterring such registrants from forwarding notifications to people who the owner does not wish to receive such notifications.

In another aspect, the anonymous notification system 100 described above in reference to FIGS. 1-3 may be adapted to provide status information to friends and family of loved ones who are residents of an assisted living facility (e.g., nursing homes, hospice care facilities, etc.). In such an implementation, administrators of the assisted living facility may be given access to the server via a website account or software application which would allow the administrators to manage, maintain, and assign new anonymous IDs for their residents.

Status updates for residents of the assisted living facility may be provided to various computing devices using a resident's anonymous ID in a fashion similar to that described above in conjunction FIGS. 1, 2, and 4. However, assisted living facilities may desire to provide resident status updates that do not correspond to standardized patient status updates (such as HL7 codes). For instance, staff at an assisted living facility may desire to send more specialized status notifications such as resident ABC123: “attended bridge club,” “took all medications,” “attended Yoga class,” “has gone to bed,” “ate a healthy lunch,” or “enjoyed a family visit.” To accommodate theses needs, the system may include a status update application. The status update application allows assisted living facility staff to select a resident's anonymous ID and then provides a menu of customized status updates from which the staff member may choose. Upon selection of a particular status update a notification message will be forwarded through the server to computing devices that have registered with the central server to receive status update notifications associated with a resident's anonymous ID.

FIG. 7 illustrates an example of such an implementation in more detail. FIG. 7 is a diagram showing an example of a system 700 for providing anonymous status notifications for residents of an assisted living facility. In addition, FIG. 7 illustrates the data flow within the system 700 during states (a) to (e). Briefly, the system 700 includes a server 705, computing devices 710 and 715 operated by staff member 711 and user 716 respectively, and network 720 over which the server 705 and computing devices 710 and 715 communicate.

In more detail, the system 700 represents an anonymous notification system adapted to provide status information to friends and family of loved ones who are residents of an assisted living facility. Server 705 may include any one or more computer devices in communication with network 720. For example, server 705 may include a server or set of servers that are co-located with one another or geographically distributed. Server 705 also may include cloud-based or edge network equipment and services. Server 705 hosts appropriate software to manage the anonymous notification system (e.g., an anonymous notification management system). For example, the anonymous notification management system executing on server 705 may perform tasks, such as, generating anonymous IDs, registering computing devices (e.g., computing device 715) to receive anonymous notifications, receiving status updates (e.g., from computing devices such as computing device 710), and generating and transmitting anonymous notifications. In addition, server 705 may host a web-based user interface and an assisted living facility account, through which administrators and/or staff of the assisted living facility may access and manage a set of anonymous IDs for residents of the assisted living facility.

Computing devices 710 and 715 may be any of a number of different types of computing devices including, for example, mobile phones; smartphones; personal digital assistants; laptop, tablet, and netbook computers; and desktop computers including personal computers, special purpose computers, general purpose computers, and/or combinations of special purpose and general purpose computers. Each of the computing devices 710 and 715 typically may have internal or external storage components for storing data and programs such as an operating system and one or more application programs.

Network 720 may provide direct or indirect communication links between server 705 and computing devices 710 and 715. Examples of network 720 include, for example, the Internet, wide area networks (WANs), local area networks (LANs) including wireless LANs (WLANs), analog or digital wired and wireless telephone networks (e.g., 3G and 4G networks), and/or any other delivery mechanisms for carrying data.

The states (a) to (e) depict a data flow that occurs when an example anonymous notification process is performed by the system 700. During state (a) computing device 710 obtains an anonymous ID associated with a resident of an assisted living facility to server 705. In some examples, a user may select a resident's anonymous ID from a list displayed on computing device 710. In some examples, data may be read from a machine readable code 713 encoding the resident's anonymous ID. For example, computing device 710 may include a sensor for reading machine readable codes 713 (e.g., a radio frequency identification (RFID) tag reader for reading RFID tags or a camera for scanning Quick Reaction (QR) codes). Computing device 710 also includes a status update application. The status update application allows a user (e.g., assisted living facility staff) to send anonymous status notifications about residents of the assisted living facility by scanning a machine readable code 713 associated with a resident. Thus, the status update application may make the task of sending status updates less intrusive on a staff member's time. In addition, the status update application may reduce the need to provide staff members with each resident's anonymous ID, thereby, limiting the distribution of each resident's anonymous ID and helping to ensure each resident's privacy.

For example, the status update application may activate an RFID reader on computing device 710. An RFID tag 713 encoding data for obtaining an anonymous ID associated with a resident who wishes to have anonymous notifications sent to family and/or friends may be placed by the door to the resident's room, for example. Upon scanning an RFID tag, computing device sends the data to the server 705.

During state (b), the server 705 obtains the resident's anonymous ID using the received data. For example, the server 705 may decode the data to obtain the resident's anonymous ID. The server 705 then provides a list of selectable status updates 712 for display on the computing device 710, state (c). The list of selectable status updates 712 may be a customized list of status updates relevant to residents of the assisted living facility, for example, “attended bridge club,” “took all medications,” “attended Yoga class,” “has gone to bed,” “ate a healthy lunch,” or “enjoyed a family visit.”

During state (d), computing device 710 sends a status update to server 705. Upon receiving a selection of a particular status update from the list of selectable status updates 712, the computing device 710 sends data indicating the selection. For example, a resident, John has just laid down to bed, a staff member may scan an RFID tag 713 near the door to John's room and select the status update “has gone to bed.” Computing device 710 will then send data indicating that the status update “has gone to bed” should be sent as a notification to computing device 715 which is registered with server 705 to receive notifications associated with John's anonymous ID.

Server 705, during state (e), then generates an anonymous status notification based on the selected status update and sends the notification to computing device 715, which had previously registered to receive status notifications associated with the particular anonymous ID (e.g., John's anonymous ID). The server 715 then sends the status notification to computing device 715 proper format for which computing device 715 registered to receive notifications. For example, if user 716 registered computing device 715 with server 705 to receive notifications via text message, then server 705 would correctly format the received status update to be transmitted as a text message. Similarly, if user 716) registered computing device 715 with server 705 to receive notifications via an anonymous ID follower application executing on computing device 715, then server 705 would correctly format the received status update to be transmitted as a notification to the anonymous ID follower application.

Furthermore, server 705 may push notifications to one or more computing devices registered to follow a particular anonymous ID (e.g., using Apple Push Notification Service, Google Cloud Messaging, or other appropriate push notification protocols). In addition or alternatively, server 705 may store a temporarily store notifications associated with an anonymous user ID and transmit the notifications to registered computing devices in response to pull requests from each registered device.

In some implementations, the data for obtaining a resident's anonymous ID may not include the anonymous ID itself, but may include other information that the server 705 may use to identify the appropriate anonymous ID. For example, the data may encode a resident ID used by the assisted living facility or a resident's room number.

In some implementations, the status update application on computing device 710 may obtain a resident's anonymous ID, for example, by decoding the anonymous ID from the machine readable code data. For example, the status update application may contain appropriate information for decoding an anonymous ID received by computing device 710 when a machine readable code is scanned. In such an implementation, the status update application may not communicate with server 715 until after user (e.g., staff member) selects a status update from the list of selectable status updates. Computing device 710 may, after receiving a selection, send the status update and the decoded anonymous ID to server 705 to generate the appropriate notification and send the notification to computing device 715.

In some implementations, the list of selectable status updates may include a text box for entering a customized status update 714. In such an implementation, the status update application or the server 705 may screen a customized status update for personal identifying information and warn a staff member that submitting the customized status update may compromise the anonymity of the resident's anonymous ID and prevent the staff member from sending the customized update. The status update application or the server 705 may, also, allow the user to select whether to allow the server 715 to remove the personal identifying information, to submit the status update anyway, or to edit the status update prior to submission.

In some implementations, users may be assigned roles for updating anonymous IDs. The roles may define which anonymous IDs a user is permitted to update and/or which status updates a user is permitted to enter for anonymous IDs. For example, a staff member in charge of resident activities (e.g., an activities coordinator) may only be permitted to update anonymous IDs associated with a subset of residents who attend the activities. Furthermore, the activities coordinator may only be permitted to provide status updates related to the activities, and not, for example, status updates related to resident medications. In such implementations, roles and privileges associated with roles may be defined by the assisted living facility. For example, an assisted living facility manager who has ownership privileges of an autonomous ID account may be permitted to define roles and privileges associated with the roles. The manager may then assign appropriate roles to members of the assisted living facility staff.

In some implementations, server 705 includes one or more databases for storing resident anonymous user IDs and information related to computing devices registered to receive notifications associated with each active anonymous user ID. Furthermore, all anonymous user IDs, registered computing devices, and associated login information (e.g., passwords) may be encrypted to ensure user privacy and anonymity.

For instance, anonymous user IDs may be stored using a one-way salted SHA-256 hashing algorithm. The SHA-256 hashing algorithm is part of the SHA-2 family of hashing algorithms. The SHA-256 hashing algorithm takes a string of characters of any length and converts the string into a unique, irreversible string of characters. Thus, anonymous user IDs are stored in indecipherable strings of characters. In addition, salting includes adding an additional string of characters to the algorithm, making each individual users result different every other result produced by the algorithm, even if given the character string is input to the algorithm. Accordingly if access to the database is breached, the breaching party will not be able to determine the personal identity of each user associated with each anonymous user ID.

Data associated with computing devices registered to receive notifications associated with one or more anonymous IDs, may be stored, for example, using a key based encryption algorithm, such as AES-256. Such data may include, for example, a phone number, a user's e-mail address, a media access control (MAC) address, and/or other data identifying the second device or a user of the second device. And passwords associated with user accounts associated with anonymous ID accounts and/or devices registered to receive notifications may be stored using, for example, an adaptive password hashing algorithm, such as bcrypt.

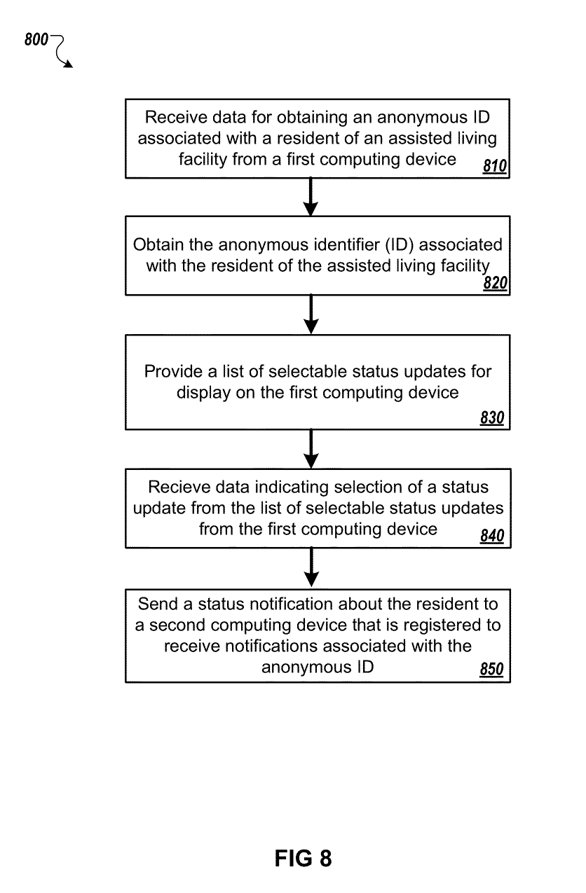

FIG. 8 is a flowchart showing an example of a process 800 for providing anonymous notifications for residents of an assisted living facility. The process 800 may be implemented by, for example, by an anonymous notification management system hosted by a server, such as server 705 of FIG. 7. Briefly, the process 800 includes receiving data for obtaining an anonymous ID associated with a resident of an assisted living facility from a first computing device, obtaining the anonymous identifier (ID) associated with the resident of the assisted living facility, providing a list of selectable status updates for display on the first computing device, receiving data indicating selection of a status update from the list of selectable status updates from the first computing device, and sending a status notification about the resident to a second computing device that is registered to receive notifications associated with the anonymous ID.

In more detail, when process 800 begins data for obtaining an anonymous ID associated with a resident of an assisted living facility from a first computing device (e.g., computing device 710 of FIG. 7) is received at a server (810). The data may encode the anonymous ID for the resident. In some implementations, the data for obtaining a resident's anonymous ID may not include the anonymous ID itself, but may include other information that the anonymous notification management system may use to identify the appropriate anonymous ID. For example, the data may encode a resident ID used by the assisted living facility or a resident's room number.

The anonymous notification management system obtains the anonymous ID associated with the resident of the assisted living facility (820). The anonymous notification management system may decode the encoded anonymous ID from the received data for obtaining the anonymous ID. In other implementations, the anonymous notification management system may use the data for obtaining the anonymous ID to identify the resident's anonymous ID from list of stored anonymous IDs.

The anonymous notification management system provides a list of selectable status updates to the first computing device 710 for display on the first computing device (830). The list of selectable status updates 712 may be a customized list of status updates relevant to residents of the assisted living facility, for example, “attended bridge club,” “took all medications,” “attended Yoga class,” “has gone to bed,” “ate a healthy lunch,” or “enjoyed a family visit.”

The anonymous notification management system receives data indicating a selection of a status update from the list of selectable status updates from the first computing device 710 (840). The data indicating a selection may include a customized status updated. For example, a status update application operating on the first computing device may allow a user (e.g., assisted living facility staff member) to enter a customized status update. In addition, the anonymous notification management system or the status update application may screen customized status updates for personal identifying information and warn the user that submitting the customized status update may compromise the anonymity of the user's anonymous ID and prevent the staff member from sending a notification based on the customized update. The anonymous notification management system or status update application may allow the user to select whether to allow the anonymous notification management system to remove the personal identifying information, to submit the status update anyway, or to edit the status update prior to submission.

Finally the anonymous notification management system sends a status notification for the anonymous ID to a second computing device (e.g., computing device 715 of FIG. 7) based on the status update (850). The status notification may be sent to the second computing device 715 via any and all methods requested by the second computing device 715 either when the user of the second computing device 715 registered to receive anonymous notifications or as altered by the user at a later time. The anonymous notification management system generates the appropriate notification (e.g., text message, e-mail, or anonymous ID follower application notification) and sends the notification to the second device 715. In addition, the anonymous notification management system may remove any personal identifying information from the received status update such that the notification includes only non-personal identifying information, thereby, ensuring the anonymity of a resident's anonymous ID. In some implementations, as described above, the anonymous notification management system or the status update application may have warned the user 711 of the first computing device 710 that a customized status update included personal identifying information. In such an implementation, if the user 711 of the first computing device 710 selected to send the update anyway the anonymous notification management system may not remove the personal identifying information.

The anonymous notification management system may also be used as a data logging system. For example, an assisted living facility (or other health care facility) may use the status updates provided in the anonymous notification management system to serve as an electronic means of logging resident and staff activities, for example, to comply with regulatory requirements and/or grant requirements. Regulatory and/or grant compliance information may include, for example, Medicare application data (e.g., data required to apply for Medicare reimbursement such as medication distribution frequency and dosage), readmission rate data to qualify for some federal reimbursements, and/or activity participation correlated with overall health and happiness of patients/residents for various grants or sponsorships. In some implementations, the anonymous notification management system may permit users (e.g., administrators) to generate reports based on anonymous ID status updates. For example, a report may list all or subset of all the status updates provided for anonymous IDs over a selected period of time (e.g., a month, a quarter, a year, etc.). In some examples, data contained in the reports may be filtered, for example, by status update type, by resident (e.g., anonymous ID), or by both. For example, the data contained in the reports may be filtered by status update type to list, for instance, only status updates of a given category (e.g., medication status updates). For example, the data contained in the reports may be filtered by resident to list, for instance, only status updates associated with a subset of one or more residents (e.g., the resident(s) associated anonymous ID). In some examples, filtering may be performed by way of one or more user selected report generation options.

In such implementations, the anonymous notification management system may include some status updates which are stored in association with an anonymous ID, but are not sent to a second computing device (e.g., computing device 715 of FIG. 7). For example, some status updates may be used primarily by a healthcare/assisted living facility for data logging purposes, and therefore, not sent to followers of the anonymous ID associated with a resident. In some implementations, the anonymous notification management system may permit users (e.g. administrators) to define which status updates are sent out to a second computing device (e.g., computing device 715 of FIG. 7) in which status updates are not sent to a second computing device. For example, a health care facility may log, but not transmit, potentially sensitive updates such as uncertain or initial diagnosis updates. Similarly, for example, an assisted living facility may log, but not transmit, a medication refusal update when a resident refuses all medications. In such a situation, assisted living facility staff may consider it more prudent to speak directly with a resident's primary contacts instead of transmitting the update to the all of the resident's anonymous ID followers.

In some examples, only portions of a status update may be sent to a second computing device (e.g., computing device 715 of FIG. 7). For example, a status update may include some information that is to be used internally by the assisted living facility and other information that may be sent to an anonymous ID follower. Such a status update may be, for example, “took all medication: [name of blood pressure medication], [name of arthritis medication], and [vitamins].” The portion “took all medications” may be sent to a second user device while the list of specific medications may be logged with the resident's anonymous ID but not sent to an anonymous ID follower.

In some implementations, the status update application includes a calendaring function whereby a user (e.g., an assisted living facility staff) may suggest optimal visiting hours and/or block off times when visiting is discouraged and request that a notification indicating the optimal and/or discouraged visiting hours be sent to a resident's family and friends (e.g., people who have registered to receive notifications associated with the resident's anonymous ID)

The anonymous notification management system may send notifications to the second computing device 715 via either push or pull protocols or both. For example, the anonymous notification management system may push notifications to one or more computing devices registered to follow a particular anonymous ID (e.g., using Apple Push Notification Service, Google Cloud Messaging, or other appropriate push notification protocols). In addition or alternatively, the anonymous notification management system may temporarily store notifications associated with an anonymous user ID and transmit the notifications to registered computing devices in response to pull requests from each registered computing device.

In some implementations, anonymous notifications may not be forwardable. That is, a user of the second computing device may be prevented from forwarding any anonymous notification sent to the second computing device. For example, the anonymous ID follower application (describe in more detail below in reference to FIG. 9) may not allow a user to copy and paste text from notifications sent to the second computing device 715 via an anonymous ID follower application. Furthermore, the anonymous notification management system may permit an owner of an anonymous ID to select limit the delivery methods that users who register to receive notifications associated with his/her anonymous ID may choose. For example, the anonymous ID owner may only permit those who register to receive notifications associated with his/her anonymous ID to receive anonymous notifications via an anonymous ID follower application, thereby, deterring such registrants from forwarding notifications to people who the owner does not wish to receive such notifications.

In some implementations, the notification may include a survey (e.g., such as one described below in reference to FIG. 10). A survey may be sent periodically (e.g., monthly, semi-annually, annually, etc.) or upon request through a web-based user interface and an assisted living facility account.

FIG. 9 illustrates several examples of graphical user interfaces (GUI) 900, 920, 940, and 960 of an anonymous ID follower application. An anonymous ID follower application serves as a user interface for receiving and tracking status notifications associated with one or more anonymous IDs for which a user of the anonymous ID follower application has registered to receive notifications. The anonymous ID follower application may store a history of status update notifications and provide links to hospital and/or third party services (discussed in more detail below). In addition, the application may serve as a user interface for anonymous ID follower application users to complete surveys (discussed in more detail in conjunction with FIG. 10 below).

GUI 900 illustrates an example of a user interface for registering to receive notifications associated with a particular anonymous ID. The GUI 900 includes a text entry box 905 and an anonymous ID submission button 910. If a user wishes to receive notifications associated with a particular anonymous ID (e.g., ABC123), for example, the user may enter the anonymous ID into the text entry box 905 and select the anonymous ID submission button 910. The anonymous ID follower application will then send a request to an anonymous notification server to register the users computing device to receive notifications associated with the particular anonymous ID.

GUI 920 illustrates an example of an anonymous notification 925 (e.g., “Status upgraded to stable”). When received, the notification 925 may interrupt any currently executing application and be displayed on a screen of a user's computing device.

GUI 940 illustrates an example of a user interface for managing anonymous IDs for which a particular anonymous ID follower application user has registered to receive notifications. The GUI 940 includes a list of selectable anonymous IDs 945 for which the anonymous ID follower application is registered to receive notifications. When a user selects one of the selectable anonymous IDs 945 the anonymous ID follower application may display GUI 960.

GUI 960 illustrates an example of a notification history 965 associated with the selected anonymous ID. Each entry 970 in the notification history 965 may be selectable to display additional details related to the particular notification. GUI 960 also includes a selectable menu of links to additional services 975. For instance, an anonymous ID follower application may permit a user of the client device to select gifts, messages, cards, flowers, to be sent to a user associated with an anonymous ID (e.g., a patient in a healthcare facility or a resident in an assisted living facility). Gifts, cards, and flower orders may be, for example, provided through the anonymous notification system to a hospital's gift shop. Messages may be sent through an anonymous notification system server to a healthcare facility patient information system and displayed to healthcare professionals as they review a patient's records within the system, for example. The healthcare professional may then print and deliver the message to the patient.

In addition or alternatively, the link to other services may be through a separate system (e.g., a “services system”). For example, when a request for services is received the request may be processed through the services system instead of through the anonymous notifications system. In order to maintain the anonymity of the patient's anonymous ID, information (e.g., Hospital address and patient room number) required to provide the additional services (e.g., deliver gifts to the patient) may be stored at the services system in association with a hashed version of the unique patient ID. For instance, when the services system receives a request for a service (e.g., a request that flowers be delivered to the patient having a unique patient ID of ABC123) from an anonymous ID follower application, the services system may perform a hashing algorithm on the patient's anonymous ID and then use the hashed unique patient ID to look up and provide delivery information to a service provider (e.g., a florist). In this manner the patient's personal information is not stored in association with the patient's unique patient ID.

Other services that may be provided to client device users through a client device application may include links for booking transportation and hotels to visit a patient, links to coupons for local business, links to driving directions, etc.

In some implementations, the anonymous ID follower application includes a calendaring function whereby users may coordinate with others users who have registered with the same anonymous ID. For example, anonymous ID follower application users may coordinate times to visit the person associated with the anonymous ID.

FIG. 10 illustrates an example of a survey graphical user interface (GUI) 1000. The GUI 1000 includes several survey questions 1010 and selectable question response buttons 1020 for answering survey questions. GUI 1000 may be provided in an anonymous notification sent to a registered computing device. For example, notifications including a survey may include a link to a website hosting GUI 1000. In addition, a notification including data representing GUI 1000 may be sent directly to an anonymous ID follower application. Surveys may be sent to computing devices registered to receive notifications associated with an anonymous ID on a periodic basis (e.g., monthly, quarterly, semiannually, annually, etc.) In addition, surveys may be sent upon receiving a survey request from a healthcare facility or an assisted living facility. In the case of a healthcare facility implementations, for example, the receipt of an HL7 code indicating that a patient was or is to be discharged may trigger a discharge survey. The discharge HL7 code may trigger a survey to be sent immediately upon receiving the code, the code may trigger a survey to be sent a predetermined period of time after the discharge code is received (e.g., 1-2 weeks after the patient's discharge), or both.

Survey questions 1010 may include customer service related questions, for example, questions related to the quality of care that a patient or resident is receiving. Survey questions 1010 for a healthcare facility survey may relate to evaluating the support system that a particular patient will have from family and friends after being discharged from the healthcare facility. For example, the questions may be targeted at evaluating the ability of members of a given patient's anonymous follower network (i.e., those family and friends who registered a computing device to receive notifications associated with the patient's anonymous ID) to assist the patient's continued recovery upon discharge from a hospital. The questions also may be targeted to evaluate how well a patient who has been discharged understands their discharge instructions (e.g., when and which medications to take, therapeutic exercises that the patient must perform, and/or when to schedule follow up appointments). Exemplary survey questions 1010 for a healthcare facility may include:

Do you feel your loved one understands his or her discharge instructions?

Do you feel your loved one understands why he or she was hospitalized?

Does the patient know the contact information for new health care provider in the event there are any follow up questions?

Would you be likely to recommend this hospital to others based on the care your loved one received?

Results of the survey may help healthcare facilities and assisted living facilities provide better services to patients, residents, and family and friends of patients and residents. For example, a study in the American Journal of Medicine identified patient characteristics and risk factors correlating to readmission within 30 days of being discharged from a hospital. Patients studied comprised patients aged 65 years or older who were participants in a Medicare-administered plan and who were urgently readmitted to the hospital within 30 days of discharge. The study identified four baseline characteristics and one discharge factor independently associated with (P<0.05) the 30-day readmission rates. The four baseline characteristics were: an age of 80 or older, previous admission within 30 days, five or more medical comorbidities, and a history of depression. The one discharge factor independently identified was lack of documented patient or family education (odds ratio=2.3; confidence interval 95%; 1.2-4.5). The study concluded that interventions such as improved discharge education programs may reduce unplanned readmission. (Factors associated with unplanned hospital readmission among patients 65 years of age and older in a Medicare managed care plan (Marcantonio, McKean, Goldfinger, Kleefield, Yurkofsky, Brennan, 1997), quoted in The American Journal of Medicine, Volume 107, Issue 1, July 1999, Pages 13-17 [http://www.sciencedirect.com/science/article/pii/S000293439900159X])

In some implementations, alert thresholds may be set for one or more medical facilities based on survey results. For example, an alert threshold may be defined by a number of negative responses to a given question or by a percentage of negative responses to a given question. As a numerical example, an alert threshold of “20% of negative responses” would mean a care network of forty clients would require 8 negative responses to trigger an alert to a healthcare facility, while a care network of clients would require two negative responses to trigger an alert.

Once an alert threshold is passed, a healthcare facility or other interested party may be notified by an anonymous notification system server. This may allow the healthcare facility to take appropriate action, for example, in accordance with procedures pre-defined by that healthcare facility. Such procedures may include soliciting further feedback from individuals within that care network by telephone, email, through an anonymous ID follower application by contacting the patient directly, or by any other useful manner.

As an example, a patient associated with anonymous ID ABC123 is discharged from a hospital. Patient ABC123's care network is notified of the discharge via an anonymous notification including a survey. One of the questions on the survey is “Does your loved one understand their discharge instructions?” In this example, a hard alert threshold of “3” has been set for this question by the hospital. If three members of the care network respond “No” to the survey question, an alert is triggered, and the hospital is notified by the anonymous notification system server.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components. As another example, while the foregoing describes an RFID tag and RFID scanner, other implementations may employ other forms of machine readable tags and appropriate scanners. For instance, other implementations may employ bar codes, Quick Recognition (QR) codes, Near Field Communication (NFC) tags, or an indoor proximity system (e.g., IBeacon) together with the appropriate scanning hardware and software. Accordingly, other implementations are within the scope of the following claims.

What is claimed is:

1. A computer implemented method comprising:
receiving, at a server, data for obtaining an anonymous ID associated with a resident of an assisted living facility from a first computing device;
obtaining the anonymous identifier (ID) associated with the resident of the assisted living facility;
providing, for display on the first computing device, a list of selectable status updates;
receiving, from the first computing device, data indicating selection of a status update from the list of selectable status updates; and
sending, to a second computing device that is registered to receive notifications associated with the anonymous ID, a status notification about the resident, the status notification being based on the selected status update.

2. The method of claim 1, wherein the list of selectable status updates includes a text entry box, and
wherein receiving, from the first computing device, data indicating selection of the status update from the list of selectable status updates comprises, receiving a user entered status update.

3. The method of claim 2, further comprising:
screening the user entered status update for personal identifying information; and
removing the personal identifying information from the user entered status update.

4. The method of claim 2, further comprising:
screening the user entered status update for personal identifying information; and
providing, for display on the first computing device, a warning that the user entered status update includes personal identifying information.

5. The method of claim 1, wherein the notification is a mobile application specific notification.

6. The method of claim 5, wherein the application specific notification is non-forwardable.

7. The method of claim 1, wherein the anonymous ID is a base 36 encoded binary number.

8. The method of claim 1, further comprising:
encrypting the anonymous ID and data associated with the anonymous ID with a one-way salted SHA-256 hashing algorithm; and
storing the encrypted anonymous ID and data associated with the anonymous ID.

9. The method of claim 1, wherein the a request from the second device to receive status notifications associated with the anonymous ID includes data related to the second computing device, and
wherein the method further comprises:
encrypting the data related to the second computing device with key-based encryption algorithm; and
storing the encrypted a data related to the second computing device.

10. A non-transitory computer-readable medium storing software comprising instructions executable by one or more processors which, upon such execution, cause the one or more processors to perform operations comprising:
receiving, at a server, data for obtaining an anonymous ID associated with a resident of an assisted living facility from a first computing device;
obtaining the anonymous identifier (ID) associated with the resident of the assisted living facility;
providing, for display on the first computing device, a list of selectable status updates;
receiving, from the first computing device, data indicating selection of a status update from the list of selectable status updates; and
sending, to a second computing device that is registered to receive notifications associated with the anonymous ID, a status notification about the resident, the status notification being based on the selected status update.

11. The non-transitory computer-readable medium of claim 10, wherein the list of selectable status updates includes a text entry box, and
wherein receiving, from the first computing device, data indicating selection of the status update from the list of selectable status updates comprises, receiving a user entered status update.

12. The non-transitory computer-readable medium of claim 11, further comprising:
screening the user entered status update for personal identifying information; and
removing the personal identifying information from the user entered status update.

13. The non-transitory computer-readable medium of claim 11, further comprising:
screening the user entered status update for personal identifying information; and
providing, for display on the first computing device, a warning that the user entered status update includes personal identifying information.

14. The non-transitory computer-readable medium of claim 10, further comprising:
encrypting the anonymous ID and data associated with the anonymous ID with a one-way salted SHA-256 hashing algorithm; and
storing the encrypted anonymous ID and data associated with the anonymous ID.

15. The non-transitory computer-readable medium of claim 10, wherein the a request from the second device to receive status notifications associated with the anonymous ID includes data related to the second computing device, and
wherein the method further comprises:
encrypting the data related to the second computing device with key-based encryption algorithm; and
storing the encrypted a data related to the second computing device.

16. A system comprising:
one or more computers and one or more storage devices storing instructions that are operable, when executed by the one or more computers, to cause the one or more computers to perform operations comprising:
receiving, at a server, data for obtaining an anonymous ID associated with a resident of an assisted living facility from a first computing device;
obtaining the anonymous identifier (ID) associated with the resident of the assisted living facility;
providing, for display on the first computing device, a list of selectable status updates;
receiving, from the first computing device, data indicating selection of a status update from the list of selectable status updates; and
sending, to a second computing device that is registered to receive notifications associated with the anonymous ID, a status notification about the resident, the status notification being based on the selected status update.

17. The system of claim 16, wherein the list of selectable status updates includes a text entry box, and
wherein receiving, from the first computing device, data indicating selection of the status update from the list of selectable status updates comprises, receiving a user entered status update.

18. The system of claim 17, further comprising:
screening the user entered status update for personal identifying information; and
removing the personal identifying information from the user entered status update.

19. The system of claim 17, further comprising:
screening the user entered status update for personal identifying information; and
providing, for display on the first computing device, a warning that the user entered status update includes personal identifying information.

20. The system of claim 16, further comprising:
encrypting the anonymous ID and data associated with the anonymous ID with a one-way salted SHA-256 hashing algorithm; and
storing the encrypted anonymous ID and data associated with the anonymous ID.
